(19) United States
(12) Patent Application Publication
(10) Pub. No.: US 2022/0385206 A1
(43) Pub. Date: Dec. 1, 2022

(54) INVERTER DEVICE

(71) Applicant: NIDEC ELESYS CORPORATION, Kanagawa (JP)

(72) Inventors: Kazuhiro SAKAI, Kanagawa (JP); Satoshi Shimazu, Kanagawa (JP); Yuhi Nakada, Kanagawa (JP)

(73) Assignee: NIDEC ELESYS CORPORATION, Kanagawa (JP)

(21) Appl. No.: 17/752,873

(22) Filed: May 25, 2022

(30) Foreign Application Priority Data
May 25, 2021 (CN) 202110573293.2

(51) Int. Cl. H02M 7/537; H02M 1/32; H02P 27/06; B60L 3/00

(52) U.S. Cl. CPC H02M 7/537; H02M 1/322; H02P 27/06; B60L 3/003; B60L 2210/40

(57) ABSTRACT

The disclosure relates to an inverter device, including: an inverter circuit including a plurality of switching elements and a capacitor; an active discharge circuit including a first discharge resistor and a discharge switch connected in series, and connected between a positive electrode and a negative electrode of the capacitor; and a control circuit including a controller respectively connected to the switching elements and the discharge switch. The controller controls the switching elements and the discharge switch. The controller turns on the discharge switch to discharge the capacitor when the controller receives a discharge command from outside the inverter device and an electric motor is rotating.

### CROSS REFERENCE TO RELATED APPLICATIONS

The present invention claims priority under 35 U.S.C. § 119 to China Application No. 202110573293.2 filed on May 25, 2021 the entire content of which is incorporated herein by reference.

### FIELD OF THE INVENTION

The disclosure relates to an in-vehicle inverter device, and particularly relates to an in-vehicle inverter device including a controller that controls discharge of a capacitor for discharging the capacitor of the inverter device when the controller receives a discharge command.

### BACKGROUND

The high-voltage safety of electric vehicles is an issue that deserves attention in the functional safety of the entire vehicle. An inverter device is required to discharge the DC capacitor in non-emergency and emergency states. The usual situation is that the ignition switch is turned off and the vehicle control device (VCU) disconnects the main relay so that the inverter device is allowed to perform discharge. An emergency state refers to a state in which a vehicle collides or a low-voltage battery loses power. All of the above situations may cause the inverter device to power off. Current Chinese regulations stipulate that the entire vehicle must be powered off within 5 seconds. Considering the time required for transmission of the discharge command, delay of the relay, and the actual turning on of the relay, the actual time left for the inverter device to discharge is only about 2 seconds in general. There are many ways to discharge, and resistor discharge and active device discharge may both be used to realize the discharge of the high-voltage DC bus.

For example, when a vehicle collides, the relay is turned off and the discharge switching element 40 is turned on so as to use the discharge resistor 30 to discharge; however, in the case of discharging while the vehicle is stopped, when the ignition switch IG is turned off, the relay is turned off, the discharge switching element 40 is turned off, and discharge is performed through the discharge resistor 100. In short, in the conventional technology, the discharge resistor 30 is used to discharge when the vehicle collides, and the discharge resistor 100 is used to discharge when the vehicle is stopped.

In the related art, in order to discharge the filter capacitor in the inverter device, an inverter circuit or a discharge resistor is generally used to discharge the filter capacitor. However, if the inverter device is not able to quickly discharge the filter capacitor in time due to the collision of the vehicle, circuit failure, etc., it may lead to vehicle failure, electric shock, etc.

FIG. 7 is a schematic diagram showing the configuration of a conventional inverter device. The conventional inverter device is provided with a discharge resistor (enclosed by a dashed line) for constantly discharging the thin film capacitor. Since the discharge resistor has a relatively large resistance value, the discharge time of the thin film capacitor is long. Therefore, the switching element is controlled according to the ADC (abbreviation of active discharge, including the meaning of quick discharge) command from the vehicle control device to cause a current to flow in the inverter (shown by a solid line) and perform discharge so that no torque is generated in the electric motor.

However, in the related art, quick discharge is not possible while the electric motor is rotating (including a situation under fail-safe control). The above-mentioned fail-safe control is a control method of the switching element for preventing damage of the switching element and overcharge of the battery. The fail-safe control is control that turns on all phases in one of the upper arm and the lower arm in the inverter circuit and turns off all phases in the other one, which is abbreviated as ASC control. The electric motor is rotating during ASC control.

### SUMMARY

An inverter device according to an exemplary embodiment of the disclosure includes: an inverter circuit connected to an electric motor of a vehicle and including a plurality of switching elements and a capacitor; an active discharge circuit including a first discharge resistor and a discharge switch connected in series, and connected in parallel with the capacitor; and a control circuit including a controller controlling the inverter circuit and the active discharge circuit. The controller turns on the discharge switch to discharge the capacitor through the first discharge resistor in response to receiving a discharge command from outside the inverter device while the electric motor is rotating.

The above and other elements, features, steps, characteristics and advantages of the present disclosure will become more apparent from the following detailed description of the preferred embodiments with reference to the attached drawings.

### BRIEF DESCRIPTION OF THE DRAWINGS

FIG. 1 is a schematic diagram showing the configuration of the inverter device according to an exemplary embodiment of the disclosure.

FIG. 2 is a flowchart showing the control of the inverter device according to an exemplary embodiment of the disclosure.

FIG. 3 is a schematic diagram showing that the inverter device of the disclosure performs discharge in the first state.

FIG. 4 is a schematic diagram showing that the inverter device of the disclosure performs discharge in the second state.

FIG. 5 is a schematic diagram showing that the inverter device of the disclosure performs discharge in the third state.

FIG. 6 is a schematic diagram showing another configuration of the inverter device according to an exemplary embodiment of the disclosure.

FIG. 7 is a schematic diagram showing the configuration of a conventional inverter device.

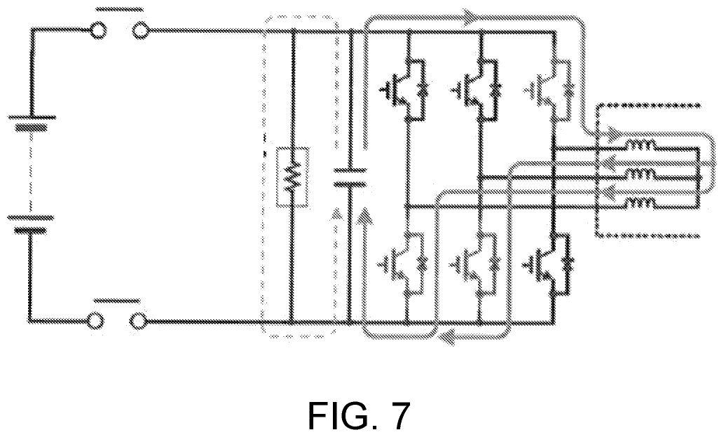

### DETAILED DESCRIPTION

Hereinafter, exemplary embodiments of the inverter device according to the disclosure will be described with reference to the drawings. In each drawing, the same or corresponding parts are denoted by the same reference numerals.

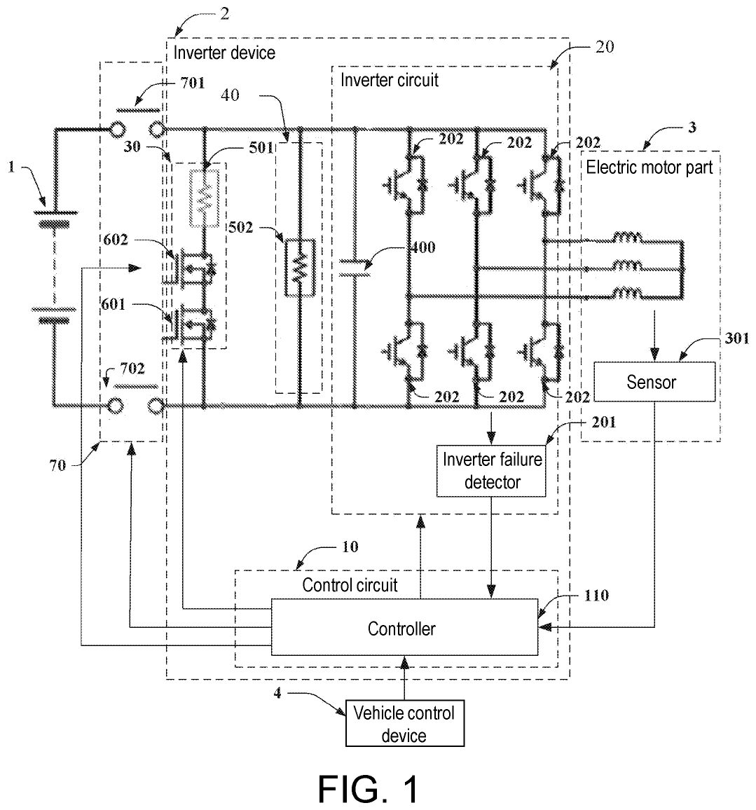

FIG. 1 is a schematic diagram showing the configuration of the inverter device 2 according to an exemplary embodiment of the disclosure. As an example, an in-vehicle electrical system of the disclosure includes: a power supply 1; an inverter device 2; an electric motor part 3; and a vehicle control device 4.

The power supply 1 is a high-voltage DC battery device, and the output voltage thereof is, for example, 300 V. The in-vehicle electrical system drives the electric motor part 3 with the output voltage of the power supply 1.

The electric motor part 3 has a rotor and a stator, and is an electric motor that is rotationally driven by the supply of three-phase AC power. For example, a permanent magnet synchronous electric motor may be used as the electric motor part 3. A sensor 301 is fixed in the electric motor part 3, and the sensor 301 is, for example, a resolver. The sensor 301 detects the rotation speed of the electric motor part 3, and the sensor 301 sends the detected rotation speed detection signal to the controller 110.

The vehicle control device 4 is a control part that controls the operating state and power output of the electric motor according to the driver's instruction, vehicle state, etc., and sends an active discharge command to the controller 110 when the vehicle stalls, a vehicle collision occurs, or vehicle failure is detected.

The inverter device 2 includes: a control circuit 10; an inverter circuit 20; an active discharge circuit 30; and a passive discharge circuit 40.

The inverter circuit 20 includes: a filter capacitor 400, an electric motor drive circuit (three upper arms, three lower arms) defined by six switching elements 202 and six gate drivers, and an inverter failure detector 201. The switching element 202 is a known circuit defined by a transistor and a freewheeling diode.

The inverter circuit 20 converts the DC power stored in the power supply 1 into three-phase AC power with a variable voltage and a variable frequency, and supplies the obtained three-phase AC power to the electric motor part 3.

The inverter failure detector 201 has a plurality of current sensors or voltage sensors provided in the inverter circuit 20, detects the current and voltage of the inverter circuit 20, determines whether the inverter circuit 20 has failed based on the current value or the voltage value detected by the above sensors, and sends a failure detection signal to the controller 110. For example, when detecting that the current or voltage in the inverter circuit 20 exceeds a predetermined value, the inverter failure detector 201 sends a failure detection signal indicating that the inverter circuit 20 is abnormal to the controller 110.

The filter capacitor 400 is connected in parallel with the electric motor drive circuit and filters the input voltage of the inverter circuit. One end of the filter capacitor 400 is connected to the positive electrode of the power supply 1 via a relay 701, and the other end is connected to the negative electrode of the power supply 1 via a relay 702. The inverter circuit 20 is provided with a voltage sensor (not shown) that detects the voltage between the positive electrode and the negative electrode of the filter capacitor 400 and sends the detected voltage signal to the controller 110.

The active discharge circuit 30 is connected between the positive electrode and the negative electrode of the filter capacitor 400 and is connected in parallel with the filter capacitor 400. The active discharge circuit 30 includes a first discharge switch 601, a second discharge switch 602, and a first discharge resistor 501, and discharges the filter capacitor 400 through the first discharge resistor 501.

Since the first discharge resistor 501 has a relatively small resistance value, the time required to discharge the filter capacitor 400 with use of the first discharge resistor 501 is relatively short so that the filter capacitor 400 is able to be quickly discharged.

The passive discharge circuit 40 is defined by a second discharge resistor 502. The second discharge resistor 502 is connected in parallel with the capacitor 400, and the resistance value of the second discharge resistor 502 is greater than the resistance value of the first discharge resistor 501. Therefore, it takes a longer time to discharge the filter capacitor 400 when the second discharge resistor 502 is used. The second discharge resistor 502 is used to discharge the filter capacitor 400.

The control circuit 10 includes the controller (CPU) 110. The controller 110 is provided in the inverter device 2, and is connected to the switching element 202, the first discharge switch 601, the second discharge switch 602, the sensor 301, the inverter failure detector 201, and the relays 701 and 702 respectively to control the inverter circuit 20, a relay part 70, and the active discharge circuit 30.

The controller 110 receives the active discharge command signal from the vehicle control device 4, the failure detection signal from the inverter failure detector 201, the rotation speed detection signal from the sensor 301, and the voltage signal from the filter capacitor 400.

The controller 110 determines whether the inverter circuit 20 has failed based on the failure detection signal from the inverter failure detector 201.

The controller 110 determines whether the electric motor part 3 is in a rotating state and the rotation speed of the electric motor part 3 based on the rotation speed detection signal from the sensor 301.

The controller 110 outputs control signals to the switching element 202 of the inverter circuit 20, the first discharge switch 601, the second discharge switch 620, and the relays 701 and 702 according to the active discharge command signal, the failure detection signal, the rotation speed detection signal, and the voltage signal of the filter capacitor 400.

The relay part 70 is defined between the external power supply 1 and the inverter device 2. On/off control of the relay part 70 is performed by the vehicle control device 4 (VCU). The relay part 70 includes the relay 701 and the relay 702. The relay 701 is a relay switch arranged between the positive electrode of the power supply 1 and the positive electrode of the filter capacitor 400. The relay 702 is a relay switch arranged between the negative electrode of the power supply 1 and the negative electrode of the filter capacitor 400. The relay 701 and the relay 702 are arranged on the side of the power supply 1 with respect to the inverter circuit 20, the active discharge circuit 30, and the passive discharge circuit 40. When discharge is performed, the relays 701 and 702 are turned off after receiving the off signal from the controller 110. For example, when the vehicle collides, the vehicle control device 4 turns off the relay part 70 through the controller 110, and sends the active discharge command to the controller 110 of the control circuit 10 of the inverter device 2. Alternatively, when the vehicle does not collide but the vehicle control device 4 turns off the relay for some reason, the vehicle control device 4 sends the active discharge command to the controller 110 of the control circuit 10 of the inverter device 2.

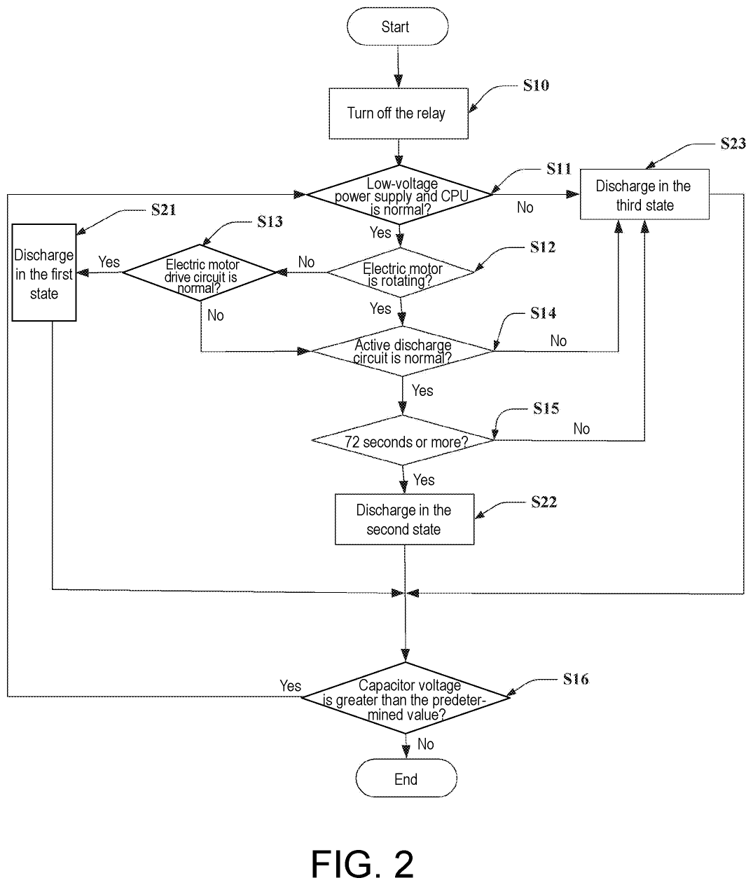

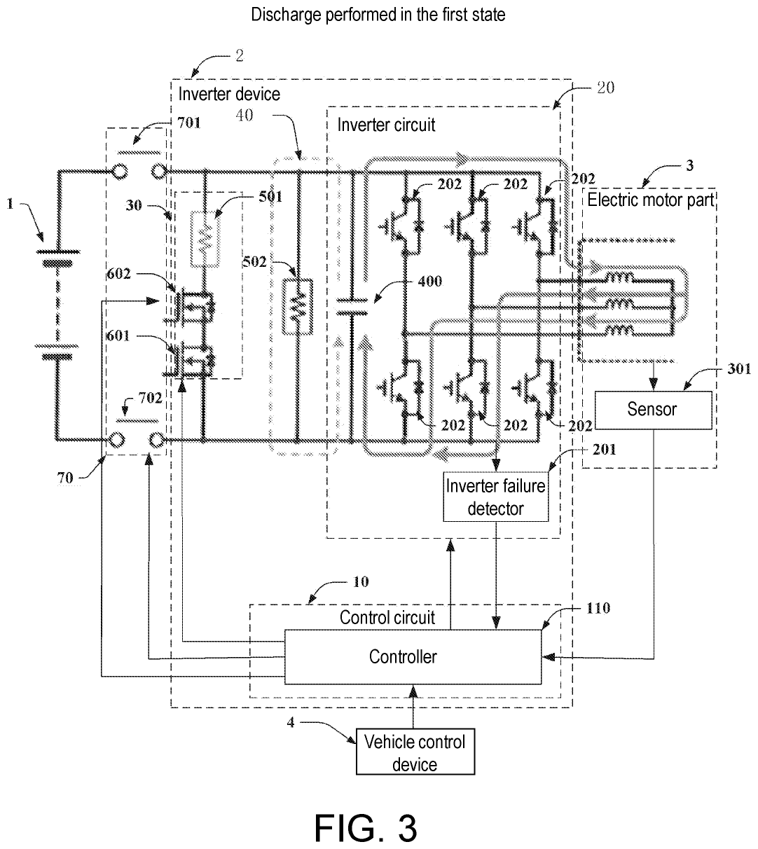

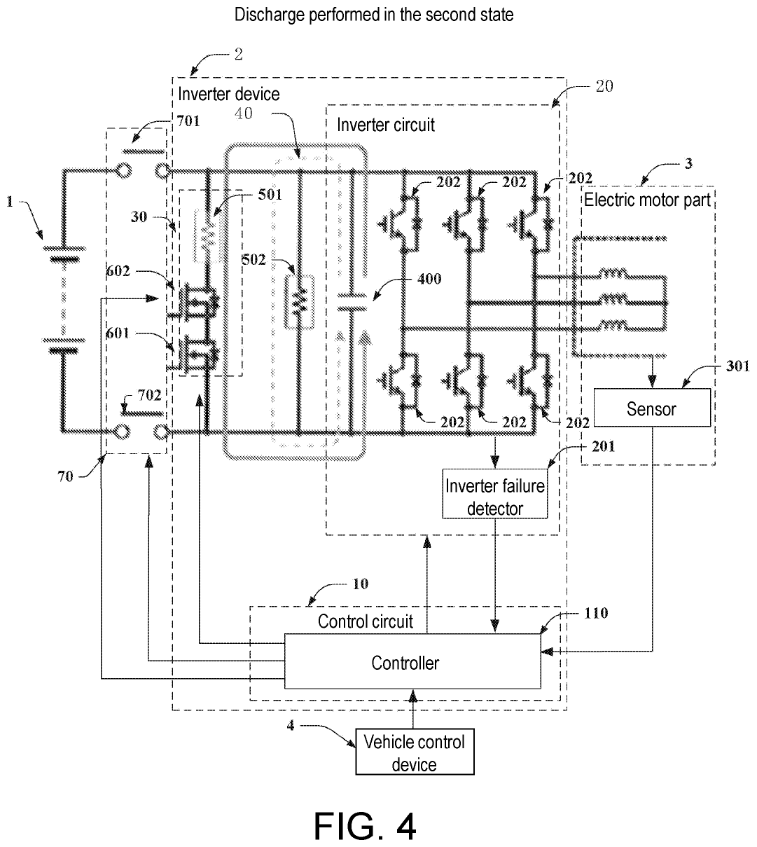

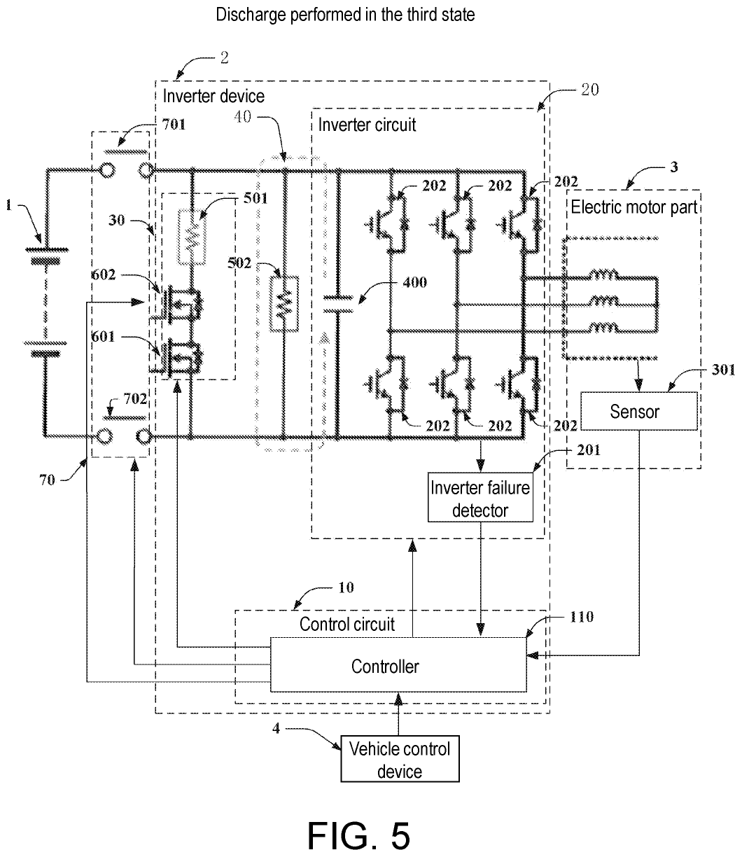

The specific operation of discharging the filter capacitor 400 will be described below with reference to FIG. 2 to FIG. 5. FIG. 2 is a flowchart showing control of the inverter device 2 according to an exemplary embodiment of the disclosure. FIG. 3 is a schematic diagram showing that the inverter device 2 of the disclosure performs discharge in a first state. FIG. 4 is a schematic diagram showing that the inverter device 2 of the disclosure performs discharge in a second state. FIG. 5 is a schematic diagram showing that the inverter device 2 of the disclosure performs discharge in a third state.

When the vehicle stalls, a vehicle collision occurs, or vehicle failure is detected, the vehicle control device 4 sends the active discharge command to the controller 110, and the controller 110 starts to perform active discharge when receiving the active discharge command sent from the vehicle control device 4 (simply referred to as VCU), and turns off the relay 701 and the relay 702 (step S10). Therefore, the power supply 1 and the filter capacitor 400 are disconnected, and the output voltage of the power supply 1 is not output to the inverter circuit 20.

The controller 110 determines whether the power supply to the control board (including the controller 110) from the low-voltage power supply (not shown) is normal, and determines whether the controller 110 (CPU) itself is normal (step S11).

When the determination result is normal (“Yes” in step S11), the processing proceeds to step S12.

In step S12, the controller 110 determines whether the electric motor part 3 is in the rotating state (that is, whether the rotation speed is greater than 0) based on the rotation speed detection signal from the sensor 301 (step S12). The rotating state here includes a state in which the electric motor is still rotating although the control of the electric motor is stopped. In addition, the rotating state also includes a state when ASC control is performed. The ASC control is control that turns on all-phase switching elements of one of the upper arm and the lower arm and turns off all-phase switching elements of the other one.

When the determination result in step S12 indicates that the electric motor part 3 is rotating (“Yes” in step S12), the processing proceeds to step S14.

In step S14, the controller 110 determines whether the active discharge circuit 30 is normal (that is, whether the first discharge switch 601, the second discharge switch 602, and the first discharge resistor 501 are normal) (step S14).

When the determination result in step S14 indicates that the active discharge circuit 30 is normal (“Yes” in step S14), the processing proceeds to step S15.

In step S15, the controller 110 determines whether the time interval from the last active discharge performed by using the first discharge resistor 501 is less than a predetermined threshold, for example, 72 seconds (step S15). The reason for setting the time interval from the last active discharge to 72 seconds or more is that a large amount of heat is generated on the first discharge resistor 501 when active discharge is performed through the first discharge resistor 501, and if the first discharge resistor 501 is not sufficiently cooled, circuit failure may occur. When the time interval from the last active discharge is 72 seconds or more, that is, when the first discharge resistor 501 is sufficiently cooled, discharge is performed through the first discharge resistor 501.

However, for example, in the case where only 71 seconds have elapsed since the last active discharge control when the controller 110 receives the active discharge command, discharge is performed through the second discharge resistor 502 as shown by the dashed arrow in FIG. 5 (that is, discharge is performed in the third state). 1 second later, 72 seconds have elapsed since the last active discharge, but the inverter device performs discharge by maintaining the current state (third state) until the controller 110 receives the next active discharge command from the vehicle control device 4.

When the determination result in step S15 indicates that the time interval from the last active discharge is 72 seconds or more (“Yes” in step S15), the processing proceeds to step S22.

In step S22, the controller 110 sends an on signal to the first discharge switch 601 and the second discharge switch 602 to turn on the first discharge switch 601 and the second discharge switch 602, and the positive electrode and the negative electrode of the filter capacitor 400 are connected through the first discharge resistor 501. As shown by the solid arrow in FIG. 4, the filter capacitor 400 is discharged through the first discharge switch 601, the second discharge switch 602, and the first discharge resistor 501 (referred to as discharge performed in the second state), and the voltage between the positive electrode and the negative electrode of the filter capacitor 400 decreases over time (step S22). The dashed arrow in FIG. 4 shows that discharge is performed through the second discharge resistor 502 while the filter capacitor 400 is discharged through the active discharge circuit 30.

When the determination result in step S15 indicates that the time interval from the last active discharge is less than 72 seconds (“No” in step S15), the processing proceeds to step S23, and the filter capacitor 400 is discharged in the third state through the second discharge resistor 502 (step S23).

When the determination result in step S12 indicates that the electric motor part 3 is not rotating (“No” in step S12), the processing proceeds to step S13.

In step S13, the controller 110 determines whether the electric motor drive circuit (including the inverter circuit 20) is normal (step S13).

When the determination result in step S13 indicates that the electric motor drive circuit (including the inverter circuit 20) is normal (“Yes” in step S13), the processing proceeds to step S21, and the controller 110 sends a control signal to the inverter circuit 20, and as shown by the solid arrow in FIG. 3, the electric charge accumulated in the filter capacitor 400 is discharged by the inverter circuit 20 (referred to as discharge performed in the first state) (step S21). The on/off relationship of the switching elements shown in FIG. 3 is an example, and any configuration may be employed as long as the six switching elements 202 are able to be used for quick discharge. The dashed arrow in FIG. 3 shows that the filter capacitor 400 is discharged through the second discharge resistor 502 while the filter capacitor 400 is discharged through the inverter circuit 20.

Further, when the determination result in step S13 indicates that the electric motor drive circuit (including the inverter circuit 20) is abnormal (“No” in step S13), the processing proceeds to step S14.

When the determination result in step S14 indicates that the active discharge circuit 30 is abnormal (“No” in step S14), the processing proceeds to step S23, and the filter capacitor 400 is discharged through the second discharge resistor 502 (step S23).

When the determination result in step S11 indicates that there is an abnormality (“No” in step S11), the processing proceeds to step S23, and the filter capacitor 400 is discharged in the third state (step S23).

After the filter capacitor 400 is discharged in steps S21, S22, and S23, the processing proceeds to step S16. In step S16, based on the voltage detection value of the filter capacitor 400, the controller 110 determines whether the voltage between the positive electrode and the negative electrode of the filter capacitor 400 is greater than a predetermined voltage (for example, 60 V). Then, when the voltage is greater than the predetermined voltage (“Yes” in step S16), the filter capacitor 400 continues to be discharged, and the processing returns to step S11. When the voltage of the filter capacitor 400 becomes equal to or less than the predetermined voltage (“No” in step S16), the discharge of the filter capacitor is completed, and the controller 110 stops the active discharge.

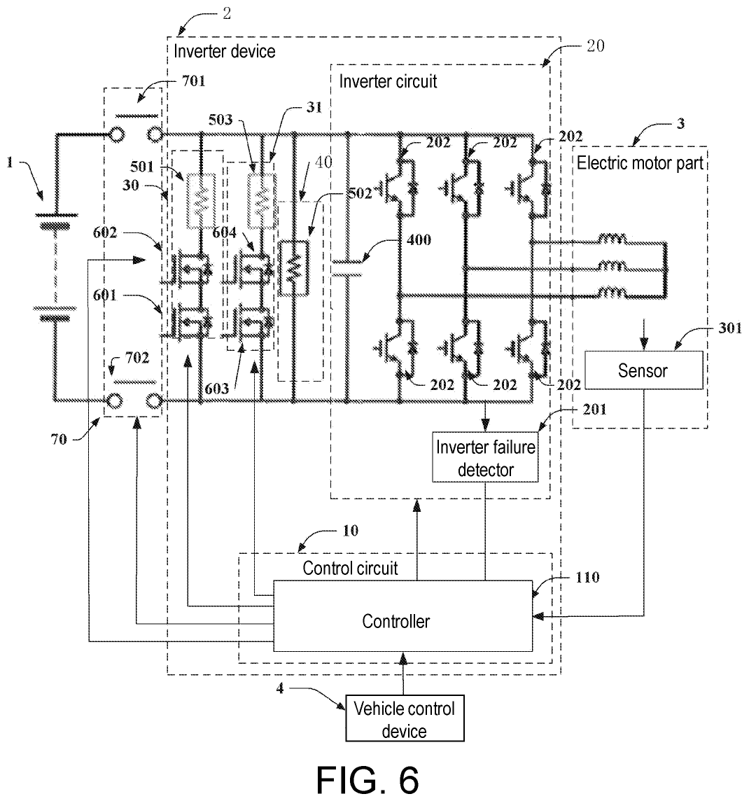

FIG. 6 is a schematic diagram showing another configuration of the inverter device according to an exemplary embodiment of the disclosure.

As shown in FIG. 6, the inverter device 2 may further include an active discharge circuit 31. The active discharge circuit 31 is connected between the positive electrode and the negative electrode of the filter capacitor 400 and has a third discharge resistor 503, a third discharge switch 603, and a fourth discharge switch 604 connected in series.

The number of active discharge circuits is not limited to one or two, and a plurality of active discharge circuits may be provided. Temperature sensors may be respectively provided in the active discharge circuits 30 and 31, and the temperature sensors are used to respectively detect the temperatures of the first discharge resistor 501 and the third discharge resistor 503, and respectively send the detected temperature detection signals to the controller.

The controller 110 is respectively connected to the temperature sensors of the third discharge switch 603, the fourth discharge switch 604, the first discharge resistor 501, and the third discharge resistor 503 to receive the temperature detection signals from the temperature sensors and control the first discharge switch 601, the second discharge switch 602, the third discharge switch 603, and the fourth discharge switch 604 according to the temperature detection signals.

The active discharge circuit is provided with a voltage sensor or a current sensor. The voltage sensor or current sensor is connected to the controller 110 to detect the voltage or current of the discharge resistor and send the detected voltage and current signals to the controller 110. The controller 110 may determine whether the active discharge circuit fails according to the detection signals from the voltage sensor and the current sensor of the active discharge circuit 30. When failure of the active discharge circuit 30 is detected (for example, when the controller 110 sends an on signal to the first discharge switch 601 and the second discharge switch 602, if the controller 110 detects that the voltage across the first discharge resistor 501 is 0, the controller 110 determines that the active discharge circuit 30 fails) but the active discharge circuit 31 does not fail, the controller 110 sends an off signal to the first discharge switch 601 and the second discharge switch 602 to turn off the first discharge switch 601 and the second discharge switch 602, and sends an on signal to the third discharge switch 603 and the fourth discharge switch 604 to turn on the third discharge switch 603 and the fourth discharge switch 604 so as to discharge the filter capacitor 400 through the third discharge resistor 503, the third discharge switch 603, and the fourth discharge switch 604. Accordingly, when a certain active discharge circuit (discharge switch, discharge resistor) fails, the other active discharge circuits may be used to discharge the filter capacitor, thereby improving the safety of the inverter device.

In addition, when the temperature detection signal of the first discharge resistor 501 is less than a first predetermined value (for example, 40 degrees), the controller 110 may turn on the first discharge switch 601 and the second discharge switch 602, and when the temperature detection signal of the first discharge resistor 501 is greater than a second predetermined value (for example, 85 degrees), the controller 110 may turn off the first discharge switch 601 and the second discharge switch 602, thereby preventing an excessively high temperature of the discharge resistor from causing damage to the circuit components and avoiding circuit failure. In addition, when the temperature detection signal of the first discharge resistor 501 is greater than the second predetermined value (for example, 85 degrees) and the temperature of the third discharge resistor 503 is less than the first predetermined value (for example, 40 degrees), the controller 110 sends an off signal to the first discharge switch 601 and the second discharge switch 602 to turn off the first discharge switch 601 and the second discharge switch 602, and sends an on signal to the third discharge switch 603 and the fourth discharge switch 604 to turn on the third discharge switch 603 and the fourth discharge switch 604 so as to discharge the filter capacitor 400 through the third discharge resistor 503, the third discharge switch 603, and the fourth discharge switch 604.

When the controller 110 receives the active discharge command, and detects that the electric motor is rotating or the switching element, etc. of the inverter circuit 20 has failed based on the failure detection signal and the rotation speed detection signal, the controller 110 sends control signals respectively to the first discharge switch 601 and the second discharge switch 602 to control on/off of the active discharge circuit 30, thereby quickly discharging the filter capacitor 400 through the first discharge resistor 501.

Moreover, when the controller 110 receives an abnormality notification from the inverter failure detector 201, the controller 110 determines whether the rotation speed of the electric motor part 3 exceeds 4000 rpm based on the signal of the sensor 301. If the rotation speed of the electric motor part 3 does not exceed 4000 rpm, the torque control is maintained and not changed. If the rotation speed of the electric motor part 3 exceeds 4000 rpm, fail-safe control is started. If the controller 110 receives the active discharge command during fail-safe control, the controller 110 sends an on signal to the first discharge switch 601 and the second discharge switch 602 to discharge the filter capacitor 400 through the active discharge circuit 30.

According to the inverter device of the disclosure, when the controller 110 receives a discharge command from outside the inverter device while the electric motor is rotating, the discharge switch is turned on to discharge the filter capacitor 400 through the first discharge resistor 501. Therefore, even when the electric motor is rotating (a state where the tires are continuously rotated due to malfunction, etc. or emergency in the process of performing fail-safe control, that is, ASC control), the filter capacitor 400 is able to be quickly discharged through the discharge switch and the first discharge resistor 501, thereby improving safety.

According to the inverter device of the disclosure, when the electric motor is not rotating and the inverter circuit 20 is normal, the controller 110 controls on/off of the switching element 202 of the inverter circuit 20 to discharge the filter capacitor 400 through the inverter circuit 20. Therefore, even when the electric motor is not rotating or the electric motor is stopped, the filter capacitor 400 is able to be quickly discharged, thereby improving safety.

According to the inverter device of the disclosure, when the electric motor is not rotating and the inverter circuit fails, the controller 110 turns on the discharge switch to discharge the filter capacitor 400 through the first discharge resistor 501. Therefore, even when the electric motor, switching element, and related sensors fail and make it impossible to use the inverter circuit for quick discharge, the filter capacitor 400 is still able to be quickly discharged through the discharge switch, thereby improving safety.

According to the inverter device of the disclosure, the inverter circuit 20 includes the second discharge resistor 502 that is used for discharging the filter capacitor 400 and has a resistance value greater than the resistance value of the first discharge resistor 501, and the second discharge resistor 502 is connected in parallel with the filter capacitor 400. Therefore, even when the switching element, the discharge switch, etc. of the inverter circuit fail, the filter capacitor 400 is still able to be discharged through the second discharge resistor, thereby improving safety.

According to the inverter device of the disclosure, the active discharge circuit 30 includes two discharge switches connected in series. That is, on/off of the active discharge circuit 30 is controlled by providing two gate drivers and two switches in the active discharge circuit 30. Therefore, even when one of the discharge switches has failure or malfunction of being continuously turned on (for example, one discharge switch is continuously turned on), if the other discharge switch is normally turned on/off, the other switch is able to be used to turn off the circuit, and thereby reliably perform discharge control on the filter capacitor 400 and prevent unnecessary discharge (that is, the first discharge resistor continues to be in a heat-generating state).

According to the inverter device of the disclosure, when detecting failure of the inverter circuit 20 and receiving the discharge command, the controller 110 turns on the discharge switch so as to discharge the filter capacitor 400 through the first discharge resistor 501. Therefore, the filter capacitor 400 is discharged through the first discharge resistor 501, which not only prevents the damage of the IGBT and the overcharge of the battery through ASC control but also discharges the filter capacitor 400 through the discharge switch to improve safety.

According to the inverter device of the disclosure, the switching element 202 may be defined by an IGBT. When the electric motor is normally driven, a large current flows through the switching elements of the inverter device. Therefore, using IGBTs as the switching elements of the inverter device is able to improve the safety of the inverter device. The discharge switch may be defined by a MOSFET. When the filter capacitor 400 is discharged, a large current does not flow through the discharge switch. Therefore, a MOSFET is used instead of an IGBT as the discharge switch to further reduce the cost.

According to the inverter device of the disclosure, two active discharge circuits 30 and 31 connected in parallel may be included. Therefore, when the discharge switch or discharge resistor of one active discharge circuit 30 fails, the active discharge circuit 31 that has not failed is able to be used to perform quick discharge to improve the safety of the inverter device. Accordingly, the filter capacitor 400 is quickly discharged even when the discharge switch or discharge resistor fails.

According to the inverter device of the disclosure, the controller may turn on the discharge switches 601 and 602 when a predetermined time has elapsed since the last discharge performed through the first discharge resistor 501. According to this configuration, the first discharge resistor 501 is able to be used again for quick discharge after a sufficient time has elapsed since the use of the first discharge resistor 501, that is, after the first discharge resistor 501 has sufficiently dissipated heat. That is, failure of the first discharge resistor 501 is prevented.

In the disclosure, the first discharge switch 601 and the second discharge switch 602 are turned on with the time elapsed since the last quick discharge (for example, 72 seconds) as a trigger, but the disclosure is not limited thereto. For example, a temperature detector may be provided to detect the temperature of the first discharge resistor 501. After confirming that the temperature of the first discharge resistor is equal to or less than a predetermined threshold, the first discharge switch 601 and the second discharge switch 602 are turned on, thereby preventing damage to the discharge resistor.

For example, a temperature sensor is provided in the active discharge circuit 30, and the temperature sensor is used to detect the temperature of the first discharge resistor 501. When the temperature of the first discharge resistor 501 is equal to or less than a predetermined threshold, the controller turns on the first discharge switch 601 and the second discharge switch 602. Therefore, there is no need to wait for a predetermined time, and as long as the first discharge resistor 501 is sufficiently cooled, the filter capacitor 400 may be discharged through the first discharge resistor 501, the first discharge switch 601, and the second discharge switch 602 so as to shorten the cooling waiting time of the discharge resistor. Further, when the temperature of the first discharge resistor is detected to be greater than a predetermined value, the discharge switch is turned off so as to prevent the circuit elements of the inverter device from being damaged due to high temperature and improve the safety of the inverter device.

It should be understood that it is possible to freely combine the components in the embodiments or appropriately modify or omit the components in the embodiments without departing from the scope of the disclosure.

Although the disclosure has been described in detail above, the above description is only an example in all respects, and the disclosure is not limited thereto. Numerous variations, not shown here, are to be construed as conceivable without departing from the scope of the disclosure.

The inverter device according to an exemplary embodiment of the disclosure is widely applicable in fields such as electric motors of EVs (electric vehicles).

Features of the above-described preferred embodiments and the modifications thereof may be combined appropriately as long as no conflict arises.

While preferred embodiments of the present disclosure have been described above, it is to be understood that variations and modifications will be apparent to those skilled in the art without departing from the scope and spirit of the present disclosure. The scope of the present disclosure, therefore, is to be determined solely by the following claims.

What is claimed is:

1. An inverter device, comprising:
an inverter circuit connected to an electric motor of a vehicle and comprising a plurality of switching elements and a capacitor;
an active discharge circuit comprising a first discharge resistor and a discharge switch connected in series, and connected in parallel with the capacitor; and
a control circuit comprising a controller controlling the inverter circuit and the active discharge circuit,
wherein the controller turns on the discharge switch to discharge the capacitor through the first discharge resistor in response to receiving a discharge command from outside the inverter device while the electric motor is rotating.

2. The inverter device of claim 1, wherein in response to the electric motor not rotating and the inverter circuit being normal, the controller controls on/off of the switching elements of the inverter circuit to discharge the capacitor through the inverter circuit.

3. The inverter device of claim 1, wherein in response to the electric motor not rotating and the inverter circuit failing, the controller turns on the discharge switch to discharge the capacitor through the first discharge resistor.

4. The inverter device of claim 1, wherein the inverter circuit further comprises a second discharge resistor for discharging the capacitor, and the second discharge resistor is connected in parallel with the capacitor, and
a resistance value of the second discharge resistor is greater than a resistance value of the first discharge resistor.

5. The inverter device of claim 1, wherein the discharge switch comprises two switches connected in series.

6. The inverter device of claim 1, wherein in response to detecting failure of the inverter circuit and receiving the discharge command, the controller turns on the discharge switch to discharge the capacitor through the first discharge resistor.

7. The inverter device of claim 1, wherein the discharge switch comprises a MOSFET.

8. The inverter device of claim 1, comprising a plurality of the active discharge circuits connected in parallel.

9. The inverter device of claim 1, wherein the controller turns on the discharge switch in response to a predetermined time having elapsed since last discharge performed through the first discharge resistor.
